(19) United States
(12) Patent Application Publication
(10) Pub. No.: US 2012/0117510 A1
(43) Pub. Date: May 10, 2012

(54) SYSTEM AND METHOD FOR AUTOMATICALLY ESTABLISHING A CONCURRENT DATA CONNECTION WITH RESPECT TO THE VOICE DIAL FEATURES OF A COMMUNICATIONS DEVICE

(75) Inventors: James Sweet, Rochester, NY (US); Stephen C. Morgana, Rochester, NY (US); R. Victor Klassen, Webster, NY (US)

(73) Assignee: Xerox Corporation, Norwalk, CT (US)

(21) Appl. No.: 12/940,414

(22) Filed: Nov. 5, 2010

(51) Int. Cl. G06F 15/16; G06F 3/048

(52) U.S. Cl. 715/810; 709/219

(57) ABSTRACT

A system and method for automatically establishing a concurrent data connection between a communications device and a remote data server upon initiating a voice call. A data connection application can be configured in association with a communications device in order to concurrently connect the communications device and a remote data server on initiating a voice call. A directory server can be employed to match an outgoing contact number with respect to the communications device with a list of data-active contact numbers stored in the directory server. If a match is found, the location data can be transmitted to the communications device. The data connection application can be further communicated with the remote data server in order to visually transmit a wide range of potential business application associated with the remote data server to the communications device.

### TECHNICAL FIELD

Embodiments are generally related to wireless communications devices and techniques. Embodiments are additionally related to the establishment of a data conduit between a wireless communications device and a remote server via a wireless communications network.

### BACKGROUND OF THE INVENTION

With the proliferation of wireless communications devices and networks, a number of businesses and other organizations have created a unique cross-platform application for communicating data with respect to a customer. A wireless communications device, such as, for example, a Smartphone and the like, is capable of providing advanced applications with a high-bandwidth external data connection. Such wireless communications devices typically include a Web browser for retrieving, presenting, and traversing information resources within a network (e.g., accessing the well-known Internet). Such a wireless communications device can be employed to access a customer-facing website of an organization and download data to enable streamlined interaction with the organization. A notification with respect to the existence of the cross-platform application can be transmitted to the user by establishing a connection to the organization website via the wireless communications device.

Most prior art approaches provide a free-of-charge mobile application, which streamlines the types of interactions the customer typically performs using the website. Such approaches are restricted to organizations having a larger customer-facing web presence. Additionally, there is no explicit way to notify the customer of the existence of such an application, if the customer does not visit the website utilizing the wireless communications device web browser. Furthermore, such prior art approaches do not provide a mechanism for advertising the existence of the cross-platform applications prior to the customer placing the call to the customer care center (e.g., a call center).

Conventionally, a business organization which operates a call center forces the customer to navigate a phone tree to route the customer with respect to a designated department in order to save extra hold time and reduce service costs for the organization operating the call center. Such phone trees can rapidly become cumbersome and significantly worsen the customer experience if the company possesses a large number of unique destinations for the customer. Also, the majority of call centers require that the customer provide identification data such as, for example, an account number, and last four digits of social security number prior to reaching a service representative of the customer care center. The insulation of such private data with respect to the customer from the service representatives can be a persistent conundrum for the customer care centers. Additionally, the service representatives can only provide voice-based instructions with respect to the customer for accessing the cross-platform application. Such prior art approaches can be frustrating, compute intensive, time consuming, and generic rather than specific to establish a data connection with respect to the wireless communications device within the business environment.

Based on the foregoing, there exists a need for an improved system and method for automatically establishing a concurrent data connection between a wireless communications device and a remote data server on initiating a voice call, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved wireless communications system and method.

It is another aspect of the disclosed embodiments to provide for an improved data connection technique concurrent with outgoing voice call.

It is further aspect of the disclosed embodiments to provide for an improved method for establishing a data connection with respect to a remote server concurrent to a voice call of a wireless communications device.

The aforementioned aspects and other objectives and advantages can now be achieved as described herein. A system and method for automatically establishing a concurrent data connection between a wireless communications device and a remote data server upon initiating a voice call is disclosed herein. A data connection application can be configured in association with a wireless communications device (e.g., a Smartphone) in order to concurrently connect the wireless communications device and a remote data server (e.g., a company-specific server) of a business organization.

A directory server can be employed to match an outgoing contact number with respect to the wireless communications device with a list of data-active contact numbers stored in the directory server. If a match is found, the location data (e.g., an IP address and/or URL) along with a relevant metadata with respect to the remote data server can be transmitted to the communications device. The data connection application can be further communicated with the remote data server in order to visually transmit a wide range of potential business application associated with the remote data server to the wireless communications device.

Alternatively, the data connection application can initiate a concurrent outgoing call. The data connection application determines the contact number of the outgoing call based on user interactions and/or data from the remote data server. The remote data server is informed that the call has been initiated and can initiate appropriate action.

The business applications with respect to the remote data server can be displayed at a user interface of the wireless communications device on initiating the voice call. The contact number of the wireless communications device can be transmitted to a private branch exchange. The particular voice connection to the wireless communications device can be located via caller identification in order to provide a voice alert to a customer with respect to the data conduit between the wireless communications device and the remote data server. A graphical navigation menu in the communications device can, for example, visually display various options with respect to the voice call of the customer in order to reduce a gross time required to present the options with respect to the remote data server. Authentication information with respect to said customer can be provided in the graphical navigation menu in order to provide a secure communication between the wireless communications device and the remote data server.

A visual aid can be transmitted to the wireless communications device in real-time in order to visually represent information with respect to the potential business application. A voice-over-internet-protocol routing can be processed when the data conduit is established between the wireless communications device and the remote data server.

A non-reversible hash with respect to the wireless communications device can be performed and the non-reversible hash can be matched with the data-active contact numbers stored on said directory server. The matched contact number can be then transmitted to the wireless communications device and the matched contact number can be locally compared with the data-active contacts in order to maintain privacy of the contact number associated with the wireless communications device. Such an approach effectively provides and manages connection with respect to the mobile customers within a wide range of business applications.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a data connection application module, an operating system, and a user interface, in accordance with the disclosed embodiments;

FIG. 3 illustrates a graphical representation of an automated business management system, in accordance with the disclosed embodiments.

FIG. 4 illustrates a high level flow chart of operations illustrating logical operational steps of a method for automatically establishing a parallel data connection on voice dial of a wireless communications device, in accordance with the disclosed embodiments;

FIG. 5 illustrates a GUI illustrating a visual phone tree with respect to the mobile communications device, in accordance with the disclosed embodiments;

FIG. 6 illustrates a GUI illustrating a secured authentication with respect to the mobile communications device, in accordance with the disclosed embodiments;

FIG. 7 illustrates a GUI illustrating a real-time visual aid with respect to the mobile communications device, in accordance with the disclosed embodiments; and

FIG. 8 illustrates a GUI illustrating a voice-over internet protocol (VOIP) with respect to the mobile communications device, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

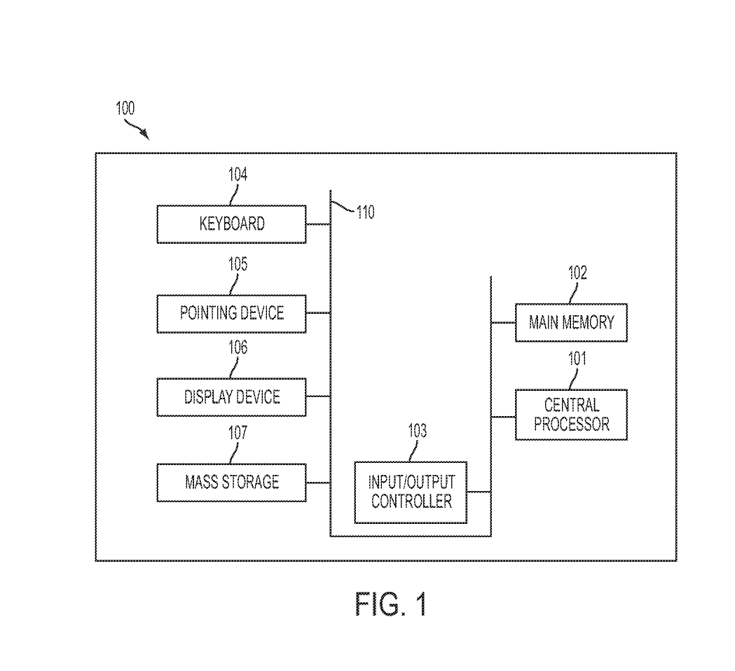

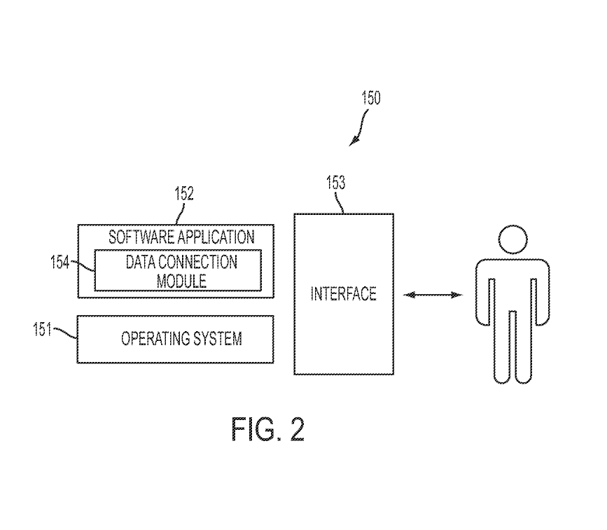

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

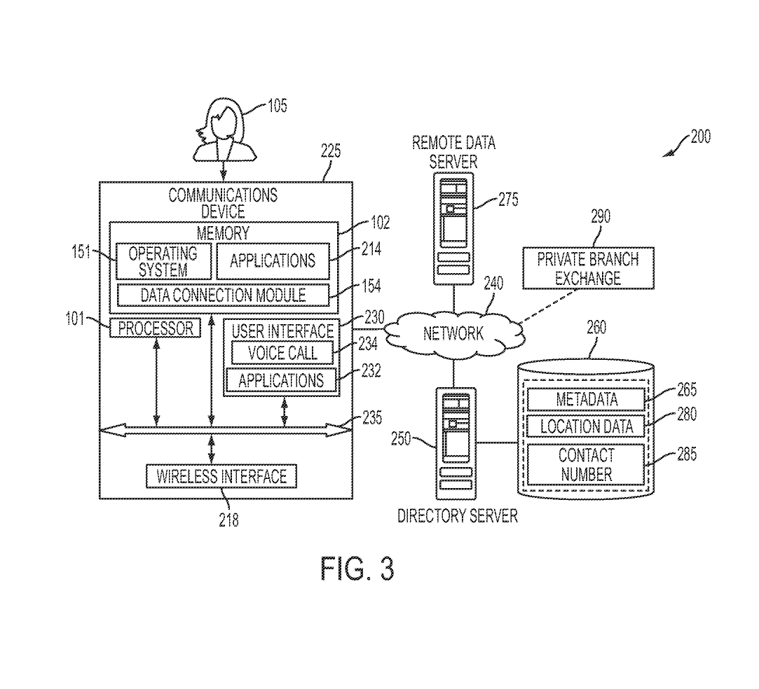

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device, such as a mouse, track ball, and pen device, etc.), a display device 106, a mass storage 107 (e.g., a hard disk), and a USB (Universal Serial Bus) peripheral connection 111. Additional input/output devices, such as an image-capturing unit 108 (e.g., camera, etc.), for example, may be associated with the data-processing system 100 as desired. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc. It can be appreciated that the data-processing system 100 can be implemented as, for example, a computing device such as a PC (Personal Computer), a communications device such as, for example, a wireless communications device (e.g., Smartphone, handheld device, laptop computer, etc), and/or wired communications devices, depending upon design considerations. An example of a communications device can be utilized, as system 100 is the communications device 225 described herein with respect to FIG. 3.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

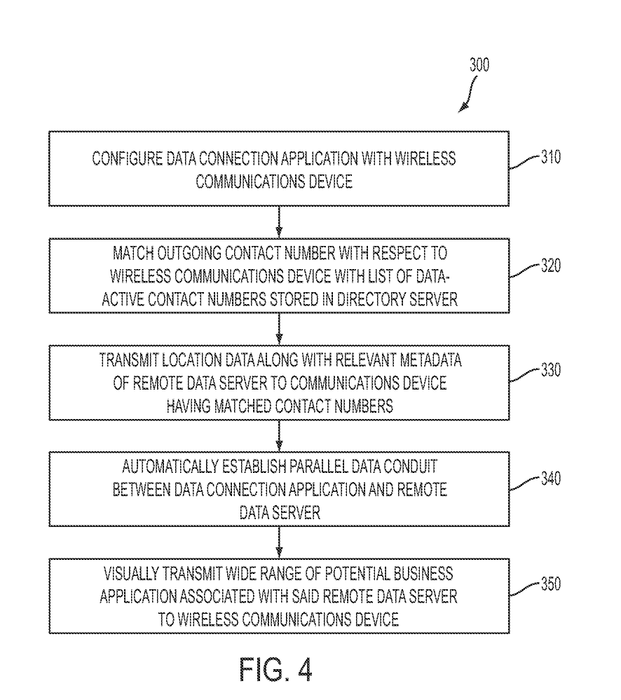

The interface 153, which is preferably a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of systems are potential. For example, rather than a traditional “Windows” system, other operation systems, such as, for example, a Real Time Operating System (RTOS) more commonly employed in wireless systems may also be employed with respect to operating system 151 and interface 153. The software application 154 can include, for example, a data connection module for establishing a parallel data conduit between a wireless communications device and a remote data server on initiating a voice call. The data connection module 154 can include instructions, such as those of method 300 discussed herein with respect to FIG. 4.

FIGS. 1-2 are thus intended as an example, and not as an architectural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, UNIX, LINUX, and the like.

FIG. 3 illustrates a graphical representation of an automated business management system 200, in accordance with the disclosed embodiments. Note that in FIGS. 1-8, identical or similar blocks are generally indicated by identical reference numerals. The automated business management system 200 can be employed to effectively communicate a potential business application with respect to a customer 105 in a wide range of business organizations such as, for example, corporate, office, education and other applications. The system 200 generally includes a communications device 225, a remote data server 275, a directory server 250 and a PBX (private branch exchange) unit 290 that are operatively configured in association with the network 240 in order to establish a concurrent data conduit between the communications device 225 and the remote data server 275 on initiating a voice call 234. Note that the communications device 225 can be, for example, a wireless communications device such as, for example, a Smartphone, a hand held communications device, a laptop computer, and so on.

The communications device 225 can be configured to include a memory 102, a processor 101 and the user interface 230 coupled to a local interface 235. The local interface 235 can be for example, a data bus with an accompanying control/address bus. A wireless interface 218 can be employed to facilitate wireless communications with other wireless devices and/or wireless networks. The memory 102 stores several components that are executable by the processor 101. The components include, for example, an operating system 151, one or more applications 214, and a data connection application module 154. Note that the communications device 225 can be a data-processing system 100 such as, for example, a Smart phone, an iPhone and/or a Blackberry. The communications device 225 includes both data and voice communications functionality and other types of communications. The communications device 225 can be configured to communicate with other devices via the network 240. Note that one or more other mobile devices 225 such as, for example, a personnel digital assistant and a laptop computer can be also configured to communicate with the remote data server 275 of the business organization.

The data connection application module 154 associated with the communications device 225 concurrently connects the communications device 225 and the remote data server 275 within the network 240. The remote data server 275 disclosed herein can be a business-specific server that provides the business applications with respect to a particular and/or multiple business applications within the network 240. The directory server 250 of the business management system 200 typically matches an outgoing contact number with respect to the communications device 225 with a list of data-active contact numbers 285 stored into a database 260 of the directory server 250. If a match is found, the directory server 250 transmits the location data 280 such as, for example an IP (internet protocol) address and/or a URL (uniform resource locator) along with a relevant metadata 265 of the remote data server 275 to the communications device 225. The data connection application module 154 associated with the communications device 225 further communicates the remote data server 275 in order to visually transmit the potential business applications associated with the remote data server 275 to the communications device 225.

The PBX (Private Branch Exchange) 290 may alert the customer 205 with respect to the data conduit The communications device 225 can transmit the contact number of the customer 205 to the remote data server 275. The remote data server 275 can further transmit the contact number associated with the customer 205 to the PBX 290 in order to confirm the establishment of a data conduit between the communications device 225 and the remote data server 275. The PBX 290 can additionally locate the remote customer 205 via a caller-ID and verify the establishment of a data conduit via an alternative recording within the business organization.

FIG. 4 illustrates a high level flow chart of operation illustrating logical operations steps of a method 300 for establishing concurrent data connection with respect to the mobile communications device 225, in accordance with the disclosed embodiments. Note that the method 300 can be implemented in the context of a computer-useable medium that contains a program product, including, for example, a module or group of modules. The data connection application 154 can be configured automatically with respect to the communications device 225 in order to establish the concurrent data conduit between the communications device 225 and the remote data server 275, as illustrated at block 310.

The outgoing contact number with respect to the communications device 225 can be matched with a list of data active contact numbers stored 285 in the database 260 of the directory server 250, as depicted at block 320. The location data along with the relevant metadata of the remote data server 275 can be transmitted to the communications device 225 having matched contact number, as indicated at block 330. A concurrent data conduit can be automatically established between the data connection application 154 and the remote data server 275, as illustrated at block 340. The varied potential business applications associated with the remote data server 275 can be transmitted visually to the communications device 225, as illustrated at block 350.

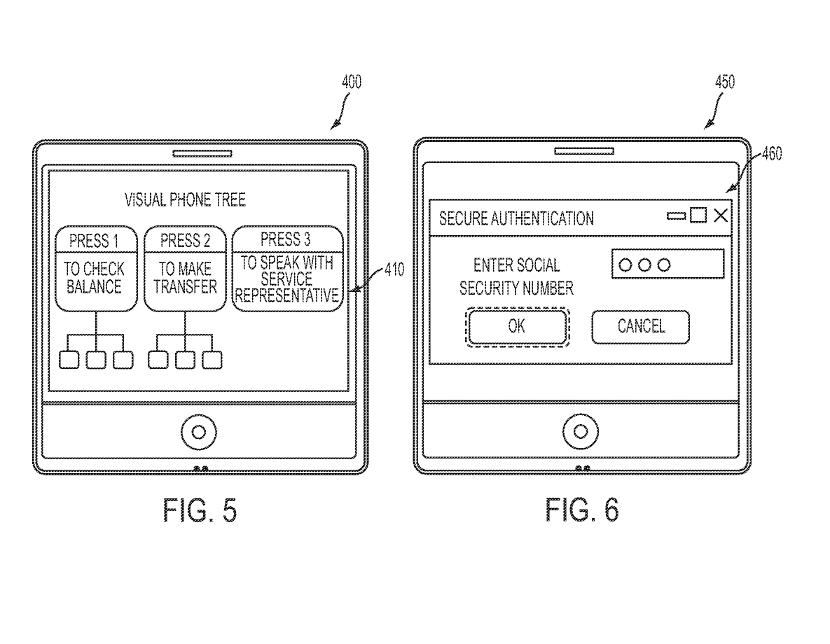

FIG. 5-8 illustrates GUI 400, 450, 500, and 550 of various business applications 232 with respect to the wireless communications system 225, in accordance with the disclosed embodiments. In the illustrated figures herein, graphical windows 400, 450, 500 and 550 are generally implemented in the context of a GUI “window”. Note that in computing, a GUI “window” is generally a visual area containing some type of user interface. Such a “window” usually (but not always) possesses a rectangular shape, and displays the output of and may allow input to one or more processes. Such windows are primarily associated with graphical displays, where they can be manipulated with a mouse cursor, such as, for example, the input device 105 depicted in FIG. 1. A GUI using “windows” as one of its main “metaphors” is often referred to as a windowing system.

The business applications 232 with respect to the communications device 225 can be displayed at the user interface 230 of the communications device 225 on initiating the voice call 234. The business applications 232 with respect to the remote data server 275 can be such as for example, a graphical navigation menu (e.g., a phone tree), a secure user authentication, a real time visual aid, a voice-over-internet-protocol (VOIP) routing and the like. FIG. 5 illustrates a GUI 400 representing the graphical navigation menu 410 with respect to the communications device 225, in accordance with the disclosed embodiments.

The graphical navigation menu 410 with respect to the communications device 225 visually displays various options such as, for example, a balance enquiry option, a fund transfer option and a service representative option with respect to the voice call 234 of the customer 205 in order to reduce a gross time required to present the options with respect to the remote data server 275. Private information can be provided with respect to the graphical navigation menu 410 in order to obtain a secured authentication within the business environment. The navigation menu 410 can be randomly accessed in order to tailor the gross time required for displaying the options with respect to the customer 205 based on his cognitive abilities. The customer can typically skim the navigation menu 410 based on his accessing abilities with respect to the communications device 225.

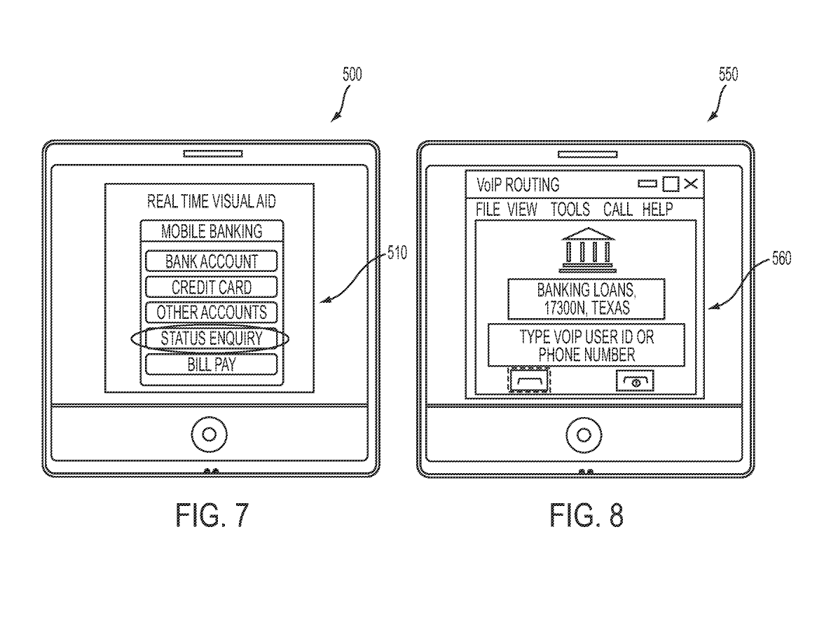

FIG. 6 illustrates a GUI 450 representing the secured authentication 460 with respect to the mobile communications device 225, in accordance with the disclosed embodiments. The secure authentication 460 with respect to the customer 205 typically initiates a user-friendly prompt on the communications device 225 where the customer can provide authentication information such as, social security numbers, credit card numbers, personnel account numbers, etc. without the accompanying security vulnerability. FIG. 7 illustrates a GUI 500 illustrating a real-time visual aid 510 with respect to the mobile communications device 225, in accordance with the disclosed embodiments. The real-time visual aids 510 such as, text information, descriptive images, screenshots, and other animations can be transmitted to the communications device in order to increase a level of descriptive detail with respect to the remote data server 275. The visual aids 510 can be provided as a screenshot of a software menu with the appropriate interactive component clearly indicated such as, a simple animation indicating the assemblage of parts, and/or a streaming video describing the maintenance on a particular product.

FIG. 8 illustrates a GUI 550 representing the VOIP routing 560 with respect to the mobile communications device 225, in accordance with the disclosed embodiments. The VOIP routing 560 can be processed in order to reduce cost related to traditional voice connections. The VOIP technology converts analog voice signals into digital data packets in order to provide real-time, two-way transmission of conversations utilizing the network IP (Internet Protocol).

A non-reversible hash can be performed with respect to the outgoing contact number and transmitted to the remote data server 275 in order to match with the contacts 285 stored in the directory server 290 for providing a secured authentication. If a match is found, all contacts matching the hash can be transmitted to the communications device 225 in order to further compare with the list of data-active contacts 285. In this manner, the privacy of a user can be further preserved, as the directory server does not receive information of which outgoing contact number was requested, only that of several matching the hash that was requested.

Based on the foregoing, it can be appreciated that a number of scenarios are possible. For example, in one scenario a user of a Smartphone has an application such as that disclosed herein loaded onto his or her Smartphone. The user calls, for example, an “ACME Widget” call centre for assistance with his or her recently purchased widget. The application notices that the user has placed a call and contacts the directory server 250 to determine whether there is a data server associated with the outgoing phone number. In this case, it turns out that there is, and the application makes the connection to the data server, and the customer experience of the user is therefore enhanced by virtue of the improved ability to navigate the phone tree visually, enter secure information, view information that the operator desires to show the user, and so forth.

In an alternative scenario the user may visit a particular site, such as, for example, an “App Store” and find an “ACME Widget” Help Accelerator Application and then load this particular application into his or her Smartphone. In such a case, the user may need assistance from the “ACME Widget” call centre and might just run the application, which at some point will place the call, but meanwhile can establish the concurrent connection described herein because it (i.e., the application) has within it, the knowledge of the address of the “ACME Widget” help desk server. In such a scenario, the user may recognize the phone number of the “ACME Widget” call center, and begin taking certain actions when the call is placed by the user, or the application could place the call. In other words, the concurrent connection can occur before or after.

The system and method disclosed herein can be employed in a wide range of business organizations such as, for example, customer care centers, product-based industries and other type of industries in order to effectively provide product information with respect to the customer. The directory server can typically generate revenue by collecting a recurring fee with respect to the client servers indexed in the database of the directory server based on a subscription basis. The directory server can provide a mapping between the contact numbers and the network services. The system and method therefore effectively provides managed connection with respect to the mobile customers within a wide range of business applications.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for automatically establishing concurrent data and voice connections, said method comprising:
associating a data connection application with a communications device to concurrently connect said communications device and a remote data server with respect to a business organization;
placing a voice call; and
automatically establishing a concurrent data conduit between said data connection application and said remote data server.

2. The method of claim 1 wherein associating said data connection with said communications device to concurrently connect said communications device and said remote data server with respect to said business organization occurs upon initiating said voice call.

3. The method of claim 2 further comprising matching an outgoing contact number with respect to said communications device with a plurality of data-active contact numbers stored in a directory server in order to thereafter transmit location data of said remote data server to said data connection application.

4. The method of claim 1 further comprising:
consulting a directory server to update a plurality of data-active contact numbers stored in said directory server; and
matching an outgoing contact number with respect to said communications device with said plurality of data-active contact numbers stored in said directory server in order to thereafter transmit location data of said remote data server to said data connection application.

5. The method of claim 1 further comprising:
transmitting a contact number of said communications device via said remote data server to a private branch exchange; and
locating said communications device via a caller identification in order to provide an alert to a customer with respect to said data conduit between said communications device and said remote data server.

6. The method of claim 1 further comprising visually displaying at least one option with respect to said voice call via a graphical navigation menu at a user interface of said communications device.

7. The method of claim 6 further comprising providing authentication information with respect to said customer in said graphical navigation menu in order to provide a secure communication between said communications device and said remote data server.

8. The method of claim 1 further comprising transmitting a visual aid to said communications device in real-time in order to visually represent information with respect to said potential business application.

9. The method of claim 1 further comprising processing a voice-over-internet-protocol routing when said data conduit is established between said communications device and said remote data server.

10. The method of claim 1 further comprising:
performing a non-reversible hash with respect to said outgoing contact number in order to thereafter match said non-reversible hash with said plurality of data-active contact numbers stored on said directory server; and
transmitting a matched contact number to said wireless communications device and locally comparing said matched contact number with said outgoing contact number in order to maintain privacy of said contact number associated with said communications device.

11. The method of claim 1 wherein said communications device comprises a wireless communications device.

12. The method of claim 1 further comprising configuring said location data with respect to said remote data server to comprise at least one of the following data:
an internet protocol address; and
a uniform resource locator.

13. A system for automatically establishing a data connection, said system comprising:
a processor;
a data bus coupled to said processor; and
a computer-usable medium embodying computer code, said computer-usable medium being coupled to said data bus, said computer program code comprising instructions executable by said processor and configured for:
associating a data connection application with a communications device to concurrently connect said communications device and a remote data server with respect to a business organization upon initiating a voice call;
matching an outgoing contact number with respect to said communications device with a plurality of data-active contact numbers stored in a directory server in order to thereafter transmit location data of said remote data server to said data connection application; and
automatically establishing a concurrent data conduit between said data connection application and said remote data server.

14. The system of claim 13 wherein said instructions are further configured for:
transmitting contact number of said communications device via said remote data server to a private branch exchange; and
locating said communications device via a caller identification in order to provide an alert to a customer with respect to said data conduit between said communications device and said remote data server.

15. The system of claim 13 wherein said instructions are further configured for visually displaying at least one option with respect to said voice call via a graphical navigation menu at a user interface of said communications device.

16. The system of claim 15 wherein said instructions are further configured for providing authentication information with respect to said customer in said graphical navigation menu in order to provide a secure communication between said communications device and said remote data server.

17. The system of claim 13 wherein said instructions are further configured for transmitting a visual aid to said communications device in real-time in order to visually represent information with respect to said potential business application.

18. The system of claim 13 wherein said instructions are further configured for processing a voice-over-internet-protocol routing when said data conduit is established between said communications device and said remote data server.

19. The system of claim 13 wherein said instructions are further configured for:
performing a non-reversible hash with respect to said outgoing contact number in order to thereafter match said non-reversible hash with said plurality of data-active contact numbers stored on said directory server; and
transmitting a matched contact number to said wireless communications device and locally comparing said matched contact number with said outgoing contact number in order to maintain privacy of said contact number associated with said communications device.

20. A system for automatically establishing a data connection, said system comprising:
a processor;
a data bus coupled to said processor; and
a computer-usable medium embodying computer code, said computer-usable medium being coupled to said data bus, said computer program code comprising instructions executable by said processor and configured for:
associating a data connection application with a wireless communications device to concurrently connect said wireless communications device and a remote data server with respect to a business organization upon initiating a voice call;
matching an outgoing contact number with respect to said wireless communications device with a plurality of data-active contact numbers stored in a directory server in order to thereafter transmit location data of said remote data server to said data connection application; and
automatically establishing a concurrent data conduit between said data connection application and said remote data server.
